(19) United States
(12) Patent Application Publication
(10) Pub. No.: US 2006/0006998 A1
(43) Pub. Date: Jan. 12, 2006

(54) Activation of personal security alarm in response to detected physiological conditions

(76) Inventor: Beth Carlson, Delray Beach, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 10/889,627

(22) Filed: Jul. 12, 2004

(51) Int. Cl. G08B 1/08

(52) U.S. Cl. 340/539.12; 340/573.1; 455/404.1

(57) ABSTRACT

A personal alarm system capable of transmitting emergency signals over a cellular telephone network to cellular telephones within a predetermined radius of the user upon activation is disclosed. The personal alarm system monitors the physiological condition of the user, compares the monitored physiological data with a predetermined physiological profile, and activates an alarm mode when the monitored physiological data exceeds normal physiological parameters. In an alternate embodiment, the personal alarm system is adapted for manual, single-hand activation.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to personal security alarm systems, and more particularly to personal alarm systems triggered by changes in the user's physiological condition resulting from an experience of fear.

2. Description of Related Art

A number of personal security alarm systems capable of generating an alarm upon activation are known in the art. Simple devices, such as an emergency whistle or horn are activated only in response to an affirmative act. Upon activation, such devices emit a loud piercing sound intended to attract the attention of those close by and/or to cause an assailant to flee. While such devices function adequately in certain limited circumstances, the requirement for user activation is a significant disadvantage, particularly in situations wherein the user is suddenly surprised or attacked without warning.

Personal alarm devices adapted for wearing on the wrist have been developed. These devices are known to operate using global positioning system (“GPS”) technology to determine the location of the user. Those devices require two free hands to activate since the user must activate the device, which is worn on one wrist, using the other hand. Once activated, the location of the user may be determined by wireless transmission of GPS signals. Requiring two free hands for activation, however, is a significant disadvantage as a person's hands may not both be free during an assault.

It is well known that a person's physiological condition responds to certain situations that instill fear or anxiety. There are numerous electromechanical systems for measuring physiological parameters such as temperature, blood pressure, respiration rate, heart rate and any number of other signs of physical condition. There exists a need for a personal alarm system capable of activation in response to the monitored physiological conditions of the user during times of stress, such as when the person is assaulted or attacked.

As a result, there exists a need for a personal security alarm system capable of activation without requiring two free hands. In addition, there exists a need for a personal security alarm system capable of activation in response to monitored physiological conditions. There further exists a need for a personal security alarm system adapted to send emergency transmissions over cellular communication networks without requiring two free hands for activation.

### BRIEF SUMMARY OF THE INVENTION

The present invention overcomes the disadvantages present in the art by providing a personal alarm system capable of transmitting emergency signals over a cellular telephone network to cellular telephones within a predetermined radius of the user upon activation. In a preferred embodiment, the personal alarm system monitors the physiological condition of the user, compares the monitored physiological data with a predetermined physiological profile, and activates an alarm mode when the monitored physiological data exceeds normal physiological parameters. In an alternate embodiment, the personal alarm system is adapted for manual, single-hand activation.

Accordingly, it is an object of the present invention to provide an improved personal security alarm system for use by individuals.

Another object of the present invention is to provide a personal security alarm system that does not require the use of two hands to activate.

Still another object of the present invention is to provide a personal security alarm system adapted for activation in response to monitored physiological conditions indicative of stress or anxiety.

Yet another object of the present invention is to provide a personal security alarm system adapted for sending an emergency signal over a cellular telecommunications network upon activation.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of a personal security alarm in accordance with the present invention embodied in a pendant;

FIGS. 2 and 3 are flow charts illustrating steps involved in activation and transmission of emergency signals over a cellular telephone network;

FIGS. 4-6 are perspective views of a personal security alarm adapted for one-handed manual activation;

FIG. 7 is a rear perspective view thereof; and

FIG. 8 illustrates a personal security alarm system in accordance with the present invention in relation to the user's hand.

### DETAILED DESCRIPTION OF THE INVENTION

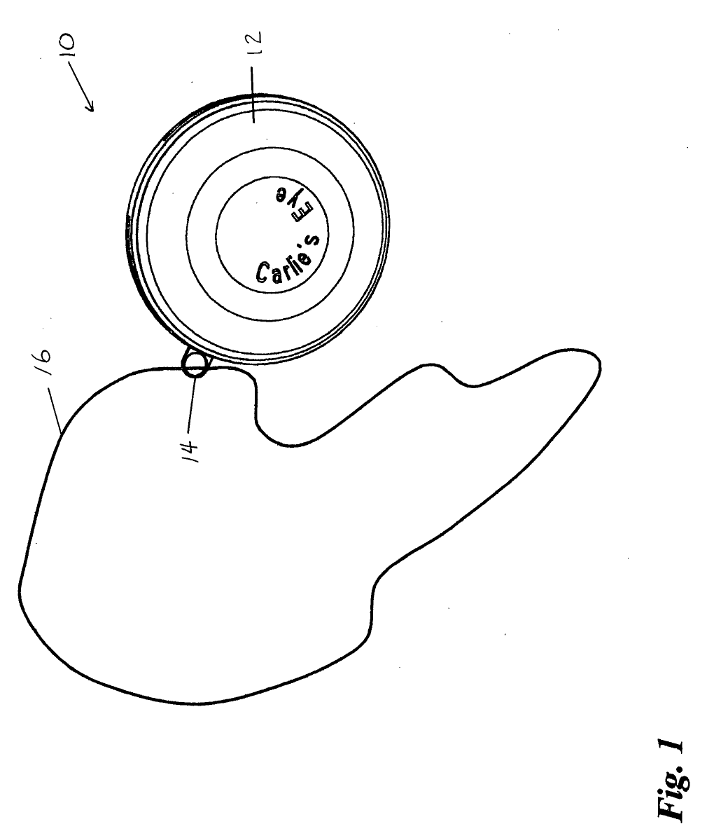

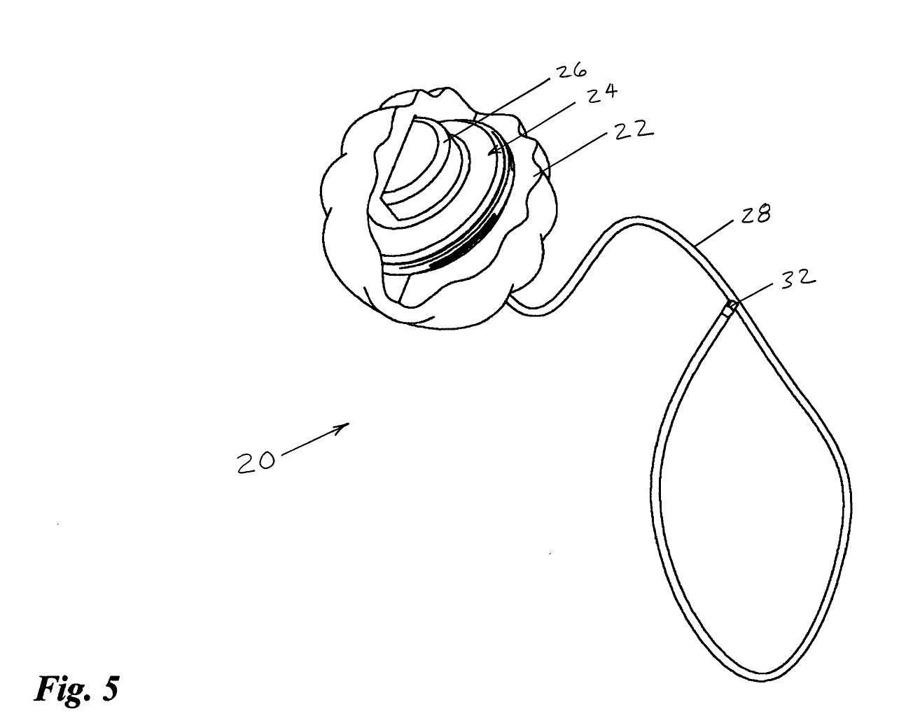

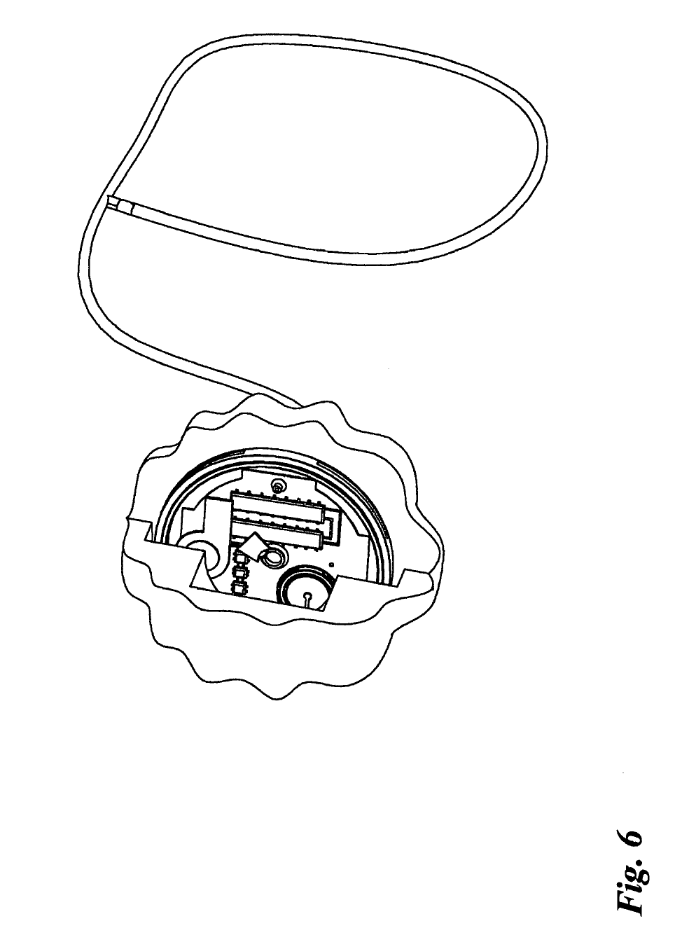

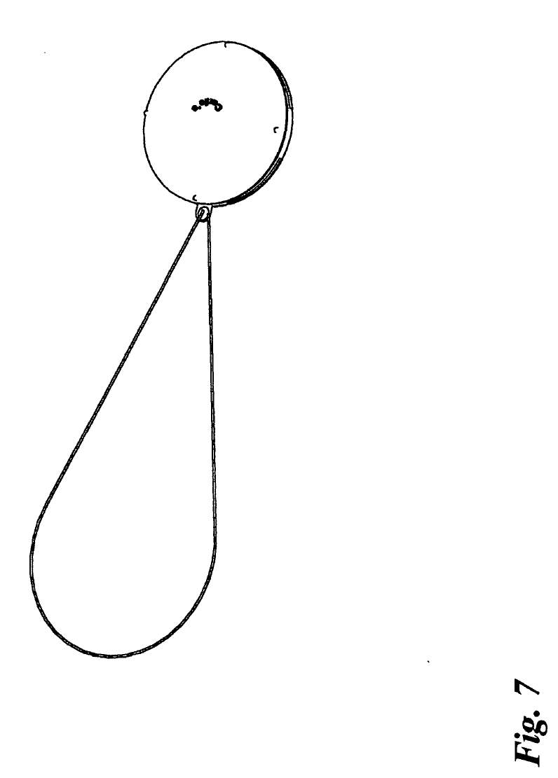

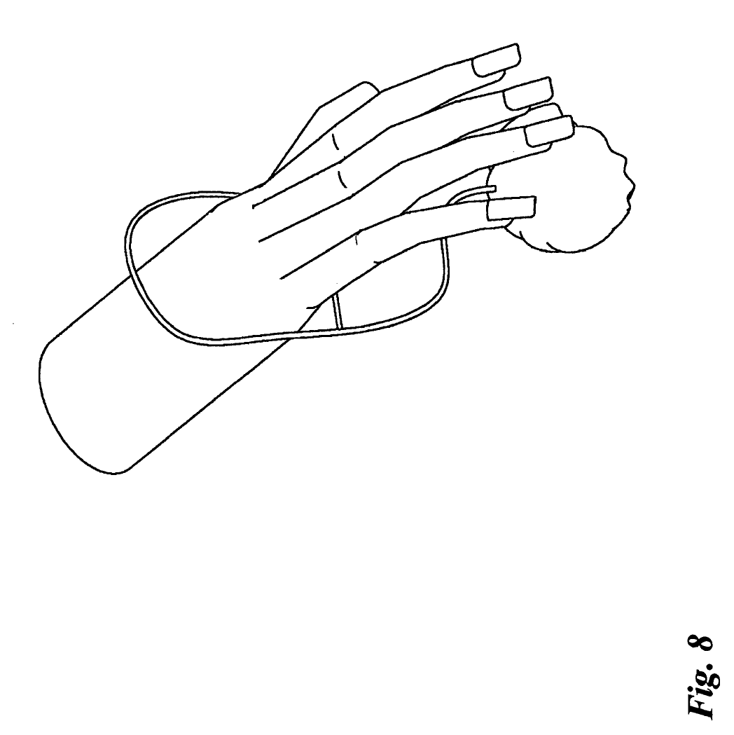

With reference now to the drawings, FIGS. 1-8 depict a personal alarm device according to the present invention capable of transmitting emergency signals over a cellular telephone network to cellular telephones within a predetermined radius of the user upon activation. As best depicted in FIG. 1, personal alarm device 10 includes a pendant housing 12, having a projecting flange defining an aperture 14. A wrist strap, cord, or chain 16 is connected to housing 12 by insertion through aperture 14 to assist the user in either holding the device or wearing the device around the neck. Personal alarm device 10 may also be adapted in a wristwatch configuration to be worn on the user's wrist.

In a preferred embodiment, personal alarm device 10 monitors the physiological condition of the user, compares the monitored physiological data with a predetermined physiological profile, and activates an alarm mode when the monitored physiological data exceeds normal physiological parameters. There are numerous electromechanical sensors for measuring physiological parameters such as temperature, blood pressure, respiration rate, heart rate and any number of other signs of physical condition. Suitable sensors for use with the present invention include: a pulse sensor, which may comprise an electro-optical coupling to sense the flow of blood in the flesh of the user; a respiration sensor, which may comprise a highly sensitive thermal element in contact with the respiration exhalation from the user; a blood pressure sensor; a perspiration sensor, which may comprise a moisture sensor to detect increased levels of perspiration; and a temperature sensor, which may comprise a thermistor for placement in thermal contact with the user. It should be understood that the present invention may be particularly adapted for monitoring any one or more of the above referenced physiological parameters.

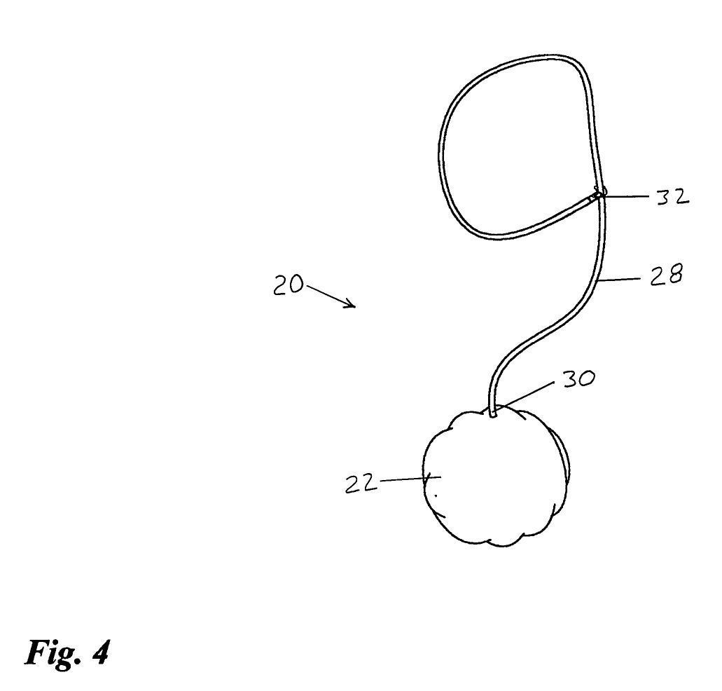

An alternate embodiment device, referenced as 20, is depicted in FIGS. 4-6. Device 20 includes a generally soft or rubberized outer shell 22, and a manually actuated electronic cellular transmitting apparatus 24 housed within said outer shell. Outer shell 22 is preferably a soft foam material that is ergonomically sized and shaped so as to be comfortably grasped by the user's hand. The manually actuated electronic cellular transmitting apparatus includes projecting push-button type actuator 26. An adjustable wrist strap 28 is provided. Wrist strap 28 includes a first end 30 connected to outer shell 22 and a second end 32 connected in slidable engagement with the remaining strap body so as to form an adjustable loop to be secured to the user's wrist. As should be apparent, this manually actuated embodiment is intended to be carried in the user's hand while being secured to the user's wrist. Device 20 is triggered when the user squeezes on outer shell 22 thereby depressing push-button actuator 26.

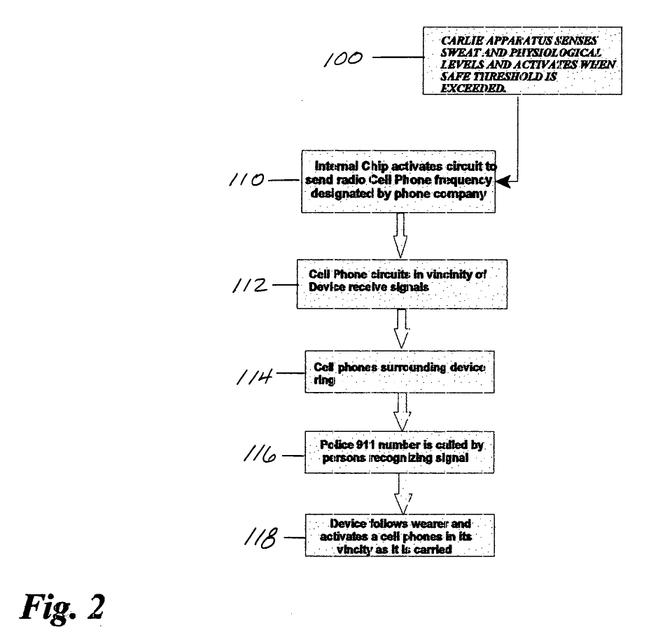

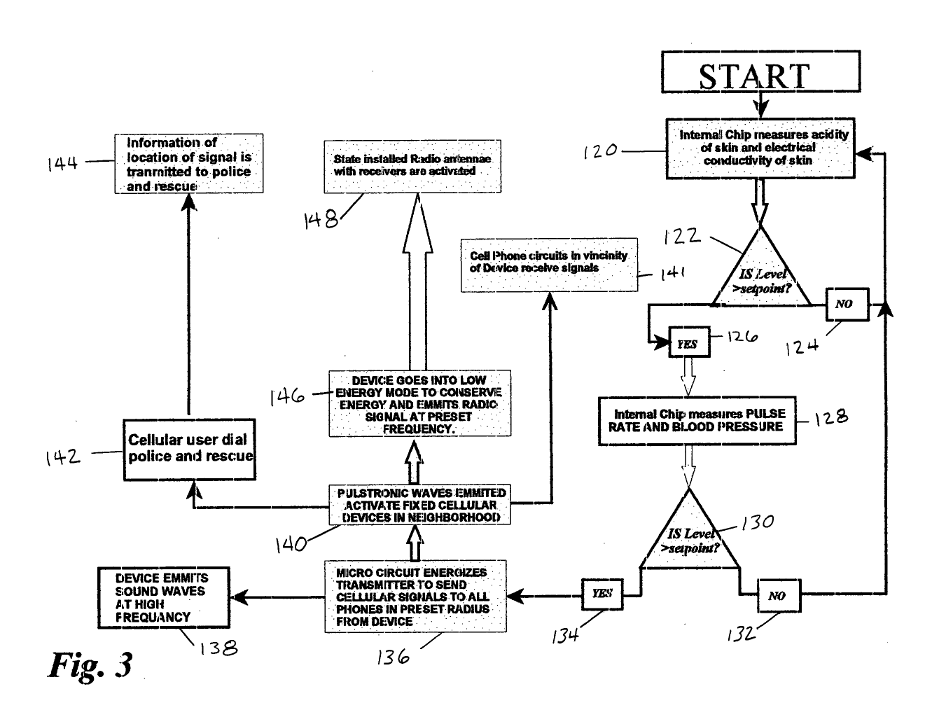

Upon activation, the present invention provides personal security by transmitting an emergency signal over cellular telephone networks as best illustrated in FIGS. 2 and 3. FIG. 2 illustrates the basic operating logic. As best depicted at 100, the system monitors the physiological condition of the user via one or more of the above-referenced sensing mechanisms, compares the monitored physiological data with a predetermined physiological profile, and activates an alarm mode when the monitored physiological data exceeds normal physiological parameters. As best depicted at 110, the system activates internal electronic circuitry for transmitting on a radio cellular telephone frequency designated by the FCC and the cellular service provider. As illustrated in 112, cellular telephones in the vicinity of the transmitting device, and preferably within a particular radius as illustrated in 114, receive the signal. The signal preferably includes an audible recorded message instructing those that receive the signal to call the police/911 as illustrated in 116. Finally, as illustrated at 118, the device travels with the wearer and continually activates cellular phones within a predetermined radius.

FIG. 3 provides a more detailed flow chart illustrating system operation. More particularly, as illustrated by block 120 the process is initiated as physiological sensors on the apparatus measure the acidity level and electrical conductivity of the skin. As illustrated by block 122, the measured levels are then compared to a predetermined threshold or set point. As noted above, the predetermined threshold for any physiological parameter is preferably a level corresponding to a state of non-stress. As illustrated by the decision block 124, if the measured level is less than the predetermined threshold then the system returns to the measuring function illustrated in block 120 to take another physiological measurement. If, however, the measured physiological data exceeds the threshold value, as illustrated by block 126, then the physiological sensors on the apparatus measure the pulse rate and blood pressure, as illustrated by block 128. As illustrated by the decision block 130, if the measured level is less than the predetermined threshold then the system returns to the measuring function illustrated in block 120 to take another physiological measurement. Accordingly, erroneous activation is prevented by requiring confirmation that physiological conditions are exceeded by two separate and independent sets of physiological measurements.

If both physiological measurements confirm that physiological parameters exceed the predetermined threshold values 122 and 130, then the device energizes the transmitter to send cellular signals to all cellular telephones in a predetermined radius of the device as illustrated by block 136. The device may also emit an audible alarm, such as a high frequency sound wave 138. The transmitted signal activates cellular device within the predetermined radius 140. The cellular telephone users who receive the signal 141 are encouraged to call the police and rescue personnel 142, and provide the police and rescue personnel with location information 144. The device then goes into a low energy mode to conserve energy 146. In the low energy mode the device will emit an intermittent radio signal at a preset frequency. The radio signal is received by a receiver system installed by the State 148.

As should now be apparent, the manually activated embodiment depicted in FIGS. 4-6 is energized manually, such as by squeezing, and thus bypasses the physiological measurement steps referenced as 120-134 in FIG. 3. Once activated, however, the device follows steps 136-148 as illustrated in FIG. 3. In addition, an embodiment is contemplated that includes both the physiological activation feature as well as the manual activation feature.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A personal security alarm system comprising:
a housing adapted to be carried by a user in contact with the user's skin;
said housing containing electrically connected electronics including an electrically connected battery power source, a microprocessor, a transmitter, and first and second physiological sensors;
means for storing data relating to the user's physiological condition, said data including physiological threshold data;
said first and second physiological sensors adapted for monitoring the physiological condition of the user to determine when the user experiences fear by comparing the monitored physiological data with the stored physiological threshold data;
means for activating said transmitter when said monitored physiological data exceeds the stored physiological threshold data; and
said transmitter adapted for transmitting an emergency signal over a cellular telephone network.

2. A personal security alarm system according to claim 1, further including means for generating an audible alarm.

3. A personal security alarm system according to claim 1, further including manual activation means for manually activating said transmitter.

4. A personal security alarm system comprising:
a housing adapted to be carried by a user in contact with the user's skin;
said housing containing electrically connected electronics including a battery power source, a microprocessor, a transmitter, and first and second physiological sensors;
means for storing data relating to the user's physiological condition, said data including physiological threshold data;
a first physiological sensor means for monitoring the acidity and electrical conductivity of the user's skin;
means for determining when the user experiences fear by comparing the monitored acidity and electrical conductivity with stored physiological threshold data;
a second physiological sensor means for monitoring the user's pulse rate and blood pressure;
means for determining when the user experiences fear by comparing the monitored pulse and blood pressure with stored physiological threshold data;
means for activating said transmitter when said monitored physiological data exceeds the stored physiological threshold data; and
said transmitter adapted for transmitting an emergency signal over a cellular telephone network.

5. A personal security alarm system according to claim 4, further including means for generating an audible alarm.

6. A personal security alarm system according to claim 4, further including manual activation means for manually activating said transmitter.

7. A personal security alarm system according to claim 4, further including an energy conservation mode activated after activation of said transmitter for causing said transmitter to conserve power by intermittently transmitting a signal.
